(19) United States
(12) Patent Application Publication
(10) Pub. No.: US 2025/0321375 A1
(43) Pub. Date: Oct. 16, 2025

(54) INTEGRATED CIRCUIT INTER-DIE COMMUNICATION USING OPTICAL TRANSMISSION STRUCTURES

(71) Applicant: Taiwan Semiconductor Manufacturing Company, Ltd., Hsinchu (TW)

(72) Inventor: Chan-Hong Chern, Palo Alto, CA (US)

(21) Appl. No.: 18/636,372

(22) Filed: Apr. 16, 2024

(51) Int. Cl. G02B 6/122; G02B 6/12; G02B 6/13

(52) U.S. Cl. CPC G02B 6/1228; G02B 6/13; G02B 2006/12107

(57) ABSTRACT

Some embodiments relate to an integrated circuit (IC) device that includes a substrate structure, a dielectric structure adjacent the substrate structure, and a plurality of dies disposed over the substrate structure. The plurality of dies includes a first die and a second die. The first die includes a first optical waveguide structure. The second die includes a second optical waveguide structure. The IC device further includes a third optical waveguide structure disposed in the dielectric structure and external to the plurality of dies. The third optical waveguide structure optically couples the first optical waveguide structure to the second optical waveguide structure.

### BACKGROUND

Significant integrated circuit (IC) development efforts have been invested in system-on-chip (SoC) systems and the like, as such systems provide augmented speed in a reduced form factor relative to systems that provide the same functionality using multiple discrete IC devices. However, some of these same SoC systems may also be associated with significant electrical power consumption and signal degradation, particularly with respect to transmission of high-frequency electrical input/output signals within the system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic plan view of some embodiments of a 2.5D system-on-chip (SoC) device in which signals transmitted between integrated circuit (IC) dies of the SoC are optical signals, according to the present disclosure.

FIGS. 2A and 2B illustrate schematic plan views of some embodiments of 2.5D SoC devices in which signals transmitted between IC dies of the SoC device are electrical or optical signals, according to the present disclosure.

FIGS. 3A and 3B illustrate schematic plan views of some embodiments of 3D SoC devices in which signals transmitted between IC dies of the SoC device are electrical or optical signals, according to the present disclosure.

FIG. 4 illustrates a cross-sectional view of some embodiments of a 2.5D SoC device including an optical waveguide structure in a dielectric layer between a plurality of IC dies and an interposer structure, according to the present disclosure.

FIGS. 5A and 5B illustrate a plan view and a cross-sectional view, respectively, of some embodiments of an IC die interface with a dielectric layer over an interposer structure for transmission of electrical and optical signals, according to the present disclosure.

FIGS. 6A through 6E illustrate plan views and corresponding cross-sectional views of optical spot-size coupler structures and corresponding optical waveguides structures for transmission of optical signals, according to the present disclosure.

FIG. 7 illustrates a cross-sectional view of some embodiments of a 2.5D SoC device including an optical waveguide structure in a dielectric layer between a plurality of IC dies and an interposer structure, according to the present disclosure.

FIGS. 8 through 12 illustrate cross-sectional views of some embodiments of 2.5D SoC devices including an optical waveguide structure in a dielectric layer among a plurality of IC dies and over an interposer structure, according to the present disclosure.

FIG. 13 illustrates a cross-sectional view of some embodiments of a 2.5D SoC device including an optical waveguide structure in a dielectric layer among a plurality of IC dies and over a package substrate structure, according to the present disclosure.

FIG. 14 illustrates a cross-sectional view of some embodiments of a 3D SoC device including an optical waveguide structure in a dielectric layer between a plurality of IC dies and an interposer structure, according to the present disclosure.

FIG. 15 illustrates a cross-sectional view of some embodiments of a 3D SoC device including an optical waveguide structure in a dielectric layer among a plurality of IC dies and over an interposer structure, according to the present disclosure.

FIG. 16 illustrates a cross-sectional view of some embodiments of a 3D SoC device including an optical waveguide structure in a dielectric layer among a plurality of IC dies and over a package substrate structure, according to the present disclosure.

FIGS. 17A through 17E illustrate cross-sectional views of some embodiments of a 2.5D SoC device including an optical waveguide structure in a dielectric layer between a plurality of IC dies and an interposer structure at multiple stages of fabrication, according to the present disclosure.

FIG. 18 illustrates a methodology of forming some embodiments of the SoC device of FIGS. 17A through 17E, according to the present disclosure.

FIGS. 19A through 19F illustrate cross-sectional views of some embodiments of a 2.5D SoC device including an optical waveguide structure in a dielectric layer among a plurality of IC dies and over an interposer structure, according to the present disclosure.

FIG. 20 illustrates a methodology of forming some embodiments of the SoC device of FIGS. 19A through 19F, according to the present disclosure.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some system-on-chip (SoC) devices, a plurality of small integrated circuit (IC) dies sometimes referred to as “chiplets” may be bonded on or over a package substrate or an interposer to form a larger, more comprehensive IC device. In some embodiments, an interposer may be an intermediate structure to which multiple dies are attached and that provides electrical connections with the package substrate. For example, the dies may be attached to an interposer by way of microbumps (e.g., small solder bumps) of a particular pitch, and the interposer may be attached to the package substrate by way of larger (e.g., controlled-collapse chip connection (C4)) solder bumps of a wider pitch. In some embodiments, the dies may be arranged in a particular configuration (e.g., a two-dimensional (2D) array).

By way of an interposer or a package substrate, the multiple dies may communicate with each other by way of electrical signals in addition to communicating with other electronic components or systems external to the SoC device. As the data speed and/or signal frequency of these electrical signals increase, the signals tend to experience significant energy loss, particularly over a relatively long distance, such as between dies that are remotely located from each other within the SoC device. Further, in some cases, additional high-power signal equalization circuits and digital-to-analog converter (DAC) and analog-to-digital converter (ADC) circuits may be used to accomplish such high-speed, long-distance signal transmission.

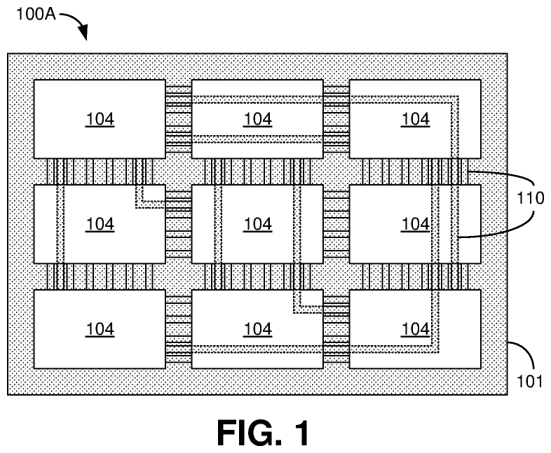

To address these issues, the present disclosure provides some embodiments of an SoC device that may employ optical signals that are carried over optical waveguide structures between dies. For example, FIG. 1 illustrates a schematic plan view of some embodiments of a 2.5D SoC device 100A in which signals transmitted between a plurality of dies 104 (e.g., arranged in a two-dimensional array) of the SoC device 100A are optical signals carried over optical waveguide structures 110, according to the present disclosure. In some embodiments, dies 104 of SoC device 100A are coupled to an interposer structure 101, which may include optical waveguide structures 110 for communicatively coupling dies 104 together. Generally, a 2.5D SoC device, as depicted in FIG. 1, carries a single level of dies 104 coupled to interposer structure 101 or a package substrate, as opposed to a 3D SoC device, in which two or more vertically stacked layers of dies 104 are provided. Also, in some embodiments, as depicted in FIG. 1, some optical waveguide structures 110 may be relatively short (e.g., to communicatively couple neighboring dies 104 together), while other optical waveguide structures 110 may be relatively long (e.g., to communicatively couple non-adjacent dies 104 together).

In some embodiments, an optical communication signal carried over one of optical waveguide structures 110 may involve a first conversion of an electrical signal to an optical signal (e.g., by an electrical-to-optical (E-O) signal converter module) in a source die 104, transmission of the optical signal over optical waveguide structure 110, and a second conversion of the optical signal to an electrical signal (e.g., by an optical-to-electrical (O-E) signal converter module) in the destination die 104. In some embodiments, this conversion process may require a significant amount of energy to perform, even when the signal is a direct-current (DC) signal or a low-frequency data or control signal.

Consequently, in some embodiments, a hybrid communication structure may be employed in which DC or low-frequency signals may be carried electrically (e.g., using electrical conductors) throughout an SoC device regardless of distance travelled therein, as such signals may be less adversely affected, and thus may consume a lower level of energy, across relatively long distances within the SoC device. Further, higher-frequency electrical communication signals that are relatively short may also be carried electrically, as such signals may not encounter the same level of energy loss as an electrical communication signal propagating over a relatively long distance within the SoC device. Accordingly, high-frequency and/or high data rate signals carried over a relatively long distance within the SoC device may first be converted to an optical signal prior to transmission over an optical waveguide structure.

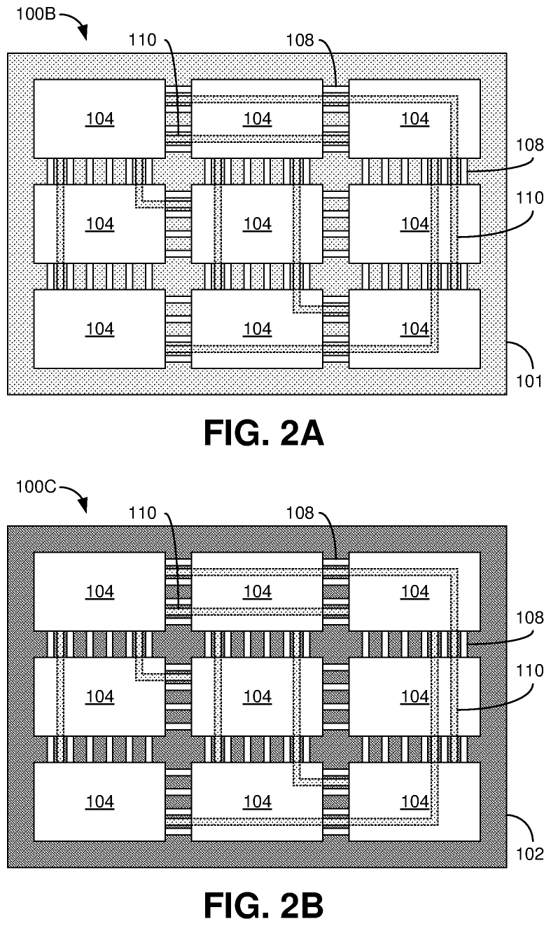

For example, FIGS. 2A and 2B illustrate schematic plan views of some embodiments of 2.5D SoC devices 100B and 100C, respectively, in which signals transmitted between dies 104 of SoC devices 100B and 100C are electrical or optical signals, according to the present disclosure. More specifically, in both FIGS. 2A and 2B, relatively short high-frequency signals (e.g., between adjacent dies 104) may be electrical signals carried over electrical conductors (e.g., metal wires) 108, while relatively long-distance high-frequency signals (e.g., between non-adjacent dies 104) may be optical signals carried over optical waveguide structures 110. As described in greater detail below, such embodiments may apply both to SoC device 100B of FIG. 2A, in which an interposer structure 101 is employed (e.g., in addition to a package substrate not explicitly shown in FIG. 2A), and to SoC device 100C of FIG. 2B, in which a package substrate structure 102 is used without an intervening interposer.

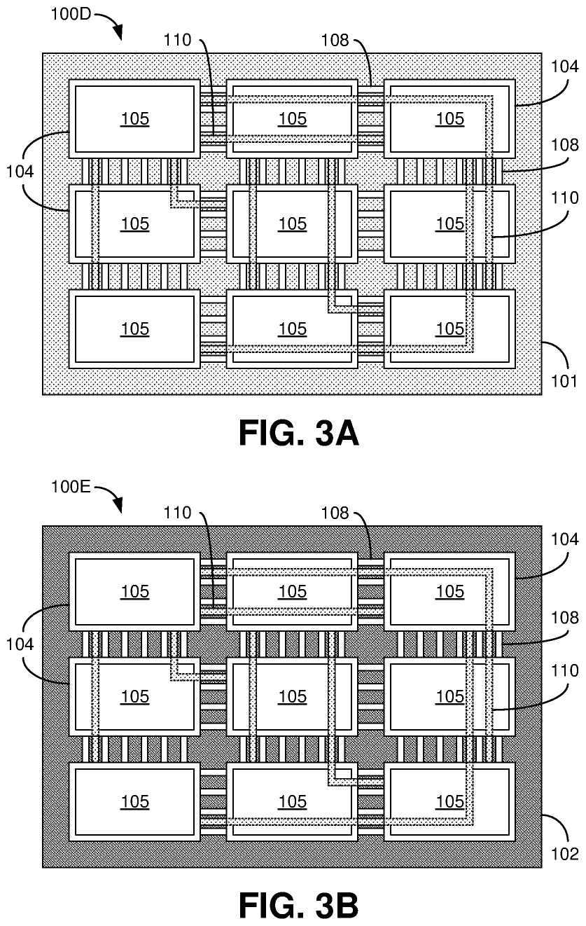

FIGS. 3A and 3B illustrate schematic plan views of some embodiments of 3D SoC devices 100D and 100E, respectively, in which signals transmitted between IC dies of the SoC devices are electrical or optical signals, according to the present disclosure. In 3D SoC devices 100D and 100E, an additional layer of dies 105 may be included, in which each die 105 is bonded to an upper surface of a corresponding die 104 that, in turn, is bonded to an interposer structure 101 (as depicted in FIG. 3A) or more directly to a package substrate structure 102 (as illustrated in FIG. 3B). In some embodiments, as discussed above in conjunction with FIGS. 2A and 2B, SoC devices 100D and 100E may use electrical conductors (e.g., metal wires) 108 to carry relatively short high-frequency signals (e.g., between adjacent dies 104), and utilize optical waveguide structures 110 to carry relatively long-distance high-frequency signals (e.g., between non-adjacent dies 104).

Accordingly, in some embodiments, such as those described above, high-performance, high data rate SoC devices may be provided that consume less energy than comparable SoC devices that do not employ optical signal transmission within the system. Further, such SoC devices may be fabricated in various technology nodes and be applied to a wide array of system types, including, but not limited to, communication switches, various processing units (e.g., “XPUs,” such as data processing units (DPUs), infrastructure processing units (IPUs), function accelerator cards (FACs), network-attached processing units (NAPUs), and so on), power management units (PMUs), memory modules, optoelectronics (OE) modules, laser modules, radio-frequency front-end modules (RF-FEMs), and application-specific ICs (ASICs) directed to various technical solutions.

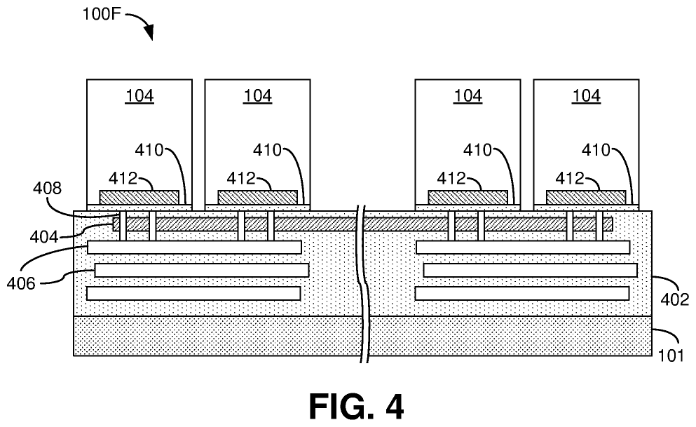

FIGS. 4 and 7 through 16 illustrate cross-sectional views of various embodiments of SoC devices incorporating various features described above. In some embodiments, an E-O signal converter may be employed to generate an optical transmission signal from an electrical signal of a first (source) IC die 104, and an O-E signal converter may be provided to convert the optical transmission signal back into an electrical signal in a second (destination) IC die 104, but such converters are not explicitly shown therein to simplify the drawings and associated discussion.

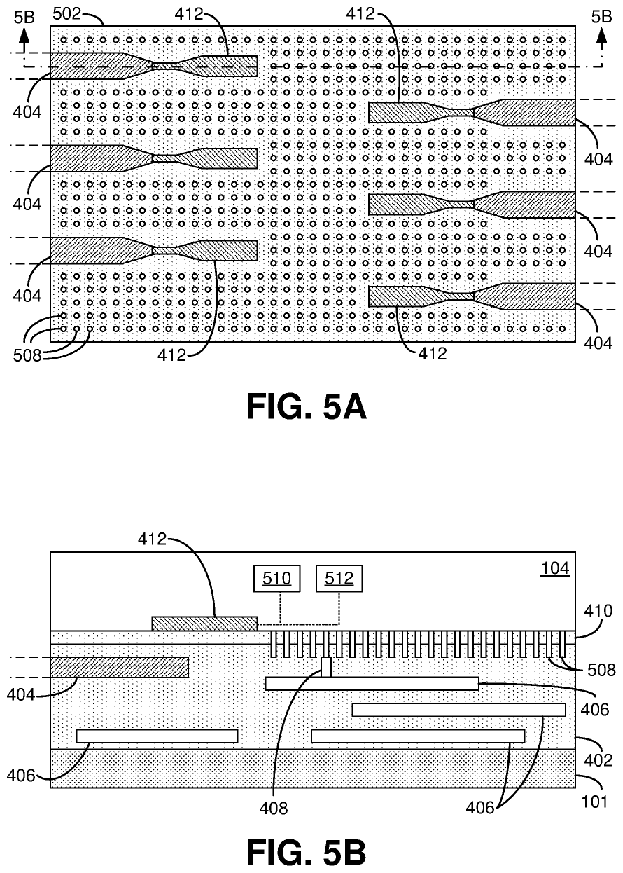

FIG. 4, for example, illustrates a cross-sectional view of some embodiments of a 2.5D SoC device 100F including an optical waveguide structure 404 in a dielectric layer 402 between a plurality of dies 104 and an interposer structure 101, according to the present disclosure. In some embodiments, as discussed in FIGS. 4 and 7 through 16, dies 104 may be formed from a single semiconductor (e.g., silicon (Si)) wafer. Each of two or more dies 104 may include a first optical waveguide structure 412 (e.g., a waveguide structure that may include silicon (Si) or another semiconductor material). Further, at least one die 104 may include an E-O signal converter module, and at least one die 104 may include an O-E signal converter module, which may be optically coupled to a corresponding first optical waveguide structure 412. The signal converter modules are depicted in FIG. 5B, but are not explicitly illustrated in some of the remaining drawings discussed herein.

In some embodiments, an oxide layer 410 (e.g., including a silicon oxide (SiOₓ), such as silicon dioxide (SiO₂), or another oxide or dielectric material) may be disposed at a lower surface of each die 104. Also, in some embodiments, first optical waveguide structure 412 may be disposed on or over oxide layer 410. As described in greater detail below in conjunction with FIG. 5B, oxide layer 410 may be formed by way of thinning a substrate of die 104 and then causing oxide growth at the substrate to create oxide layer 410.

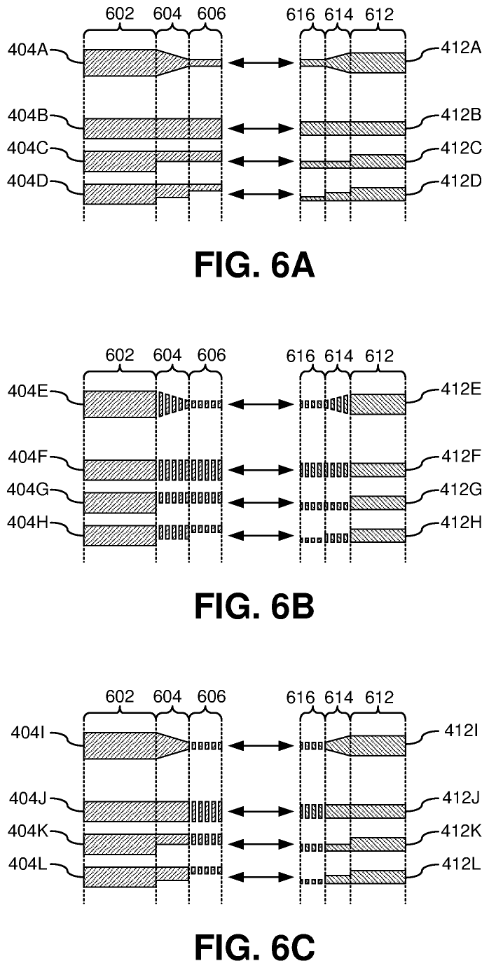

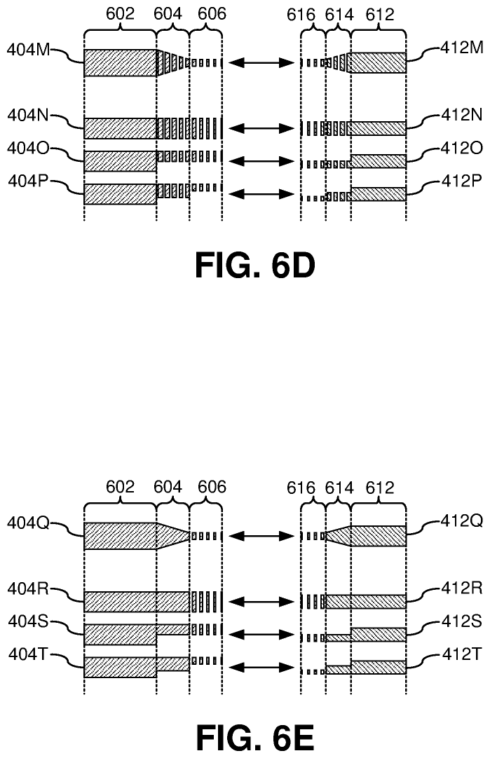

In some embodiments, the lower surface of each IC die 104 may be bonded (e.g., via thermal bonding) to a dielectric layer 402 (e.g., including a silicon oxide (SiOₓ), such as silicon dioxide (SiO₂), or another oxide or dielectric material) overlying an interposer structure 101 (e.g., a silicon (Si) interposer). In some embodiments, dielectric layer 402 may include a second optical waveguide structure 404 (e.g., a waveguide structure including silicon nitride (SiN)) that is optically coupled to first optical waveguide structure 412. In some embodiments, as discussed in greater detail in conjunction with FIGS. 5A, 5B, and 6A through 6C, first optical waveguide structure 412 and second optical waveguide structure 404 may be optically coupled by way of optical spot-size coupler structures (e.g., as the widths of first optical waveguide structure 412 and second optical waveguide structure 404 may be different). Accordingly, in some embodiments, for an electrical signal that may be transmitted over a significant distance from first to second dies 104, the electrical signal may be converted to an optical signal, which may then be transmitted by way of first optical waveguide structure 412 in first die 104, second optical waveguide structure 404 in dielectric layer 402, and first optical waveguide structure 412 in second die 104, and then converted from an optical signal back to an electrical signal for processing in second die 104. In such embodiments, the optical signal may not be subject to the same weakening characteristics as an electrical signal travelling the same distance.

Further, dielectric layer 402 may include conductive structures 406 (e.g., layers or wires of metal (e.g., copper (Cu)) or an alloy), one or more of which may be connected to IC die 104 by way of conductive vias 408 to surface contact structures (not depicted in FIG. 4) bridging the lower surface of IC die 104 and the upper surface of dielectric layer 402 (by way of bonding IC die 104 to dielectric layer 402). Examples of the surface contact structures are discussed in greater detail with respect to FIGS. 5A and 5B.

FIGS. 5A and 5B illustrate a plan view and a cross-sectional view, respectively, of some embodiments of an IC die interface 502 (e.g., for IC die 104) with a dielectric layer 402 over an interposer structure 101 for transmission of electrical and optical signals, according to the present disclosure. In some embodiments, as depicted in FIG. 5A, a plurality of surface contact structures 508 (e.g., arranged in a particular configuration, such as a 2D array) may facilitate electrical connections between IC dies 104 via conductive vias 408 and conductive structures 406.

Also depicted in FIGS. 5A and 5B are a plurality of first optical waveguide structures 412 and portions of second optical waveguide structures 404 optically coupled together (e.g., via optical spot-size coupler structures, discussed in FIGS. 6A through 6E). One of these coupled structures is shown in the cross-section of FIG. 5B, in which first optical waveguide structure 412 and associated spot-size coupler are shown partially overlying second optical waveguide structure 404.

Moreover, in some embodiments, first optical waveguide structure 412 may be optically coupled with one or both of an E-O signal converter module 510 (e.g., to provide an optical signal created from an electrical signal for transmission by way of first optical waveguide structure 412) and an O-E signal converter module (e.g., to receive an optical signal by way of first optical waveguide structure 412 for subsequent conversion to an electrical signal).

FIGS. 6A through 6E illustrate plan views and corresponding cross-sectional views of optical spot-size coupler structures and corresponding optical waveguide structures 404 and 412 for transmission of optical signals, according to the present disclosure. The optical spot-size coupler structures may be employed at least in SoC devices 100F, 100G, and 100N disclosed in FIGS. 4, 7, and 14, respectively, in some embodiments. In each of FIGS. 6A through 6E, a plan view of an embodiment of first optical waveguide structure 412 and corresponding second optical waveguide structure 404, along with three different side views of possible structures thereof, are shown. In addition, each first optical waveguide structure 412 is shown as including a waveguide portion 612, a taper portion 614, and a tip portion 616, and second optical waveguide structure 404 is depicted as having a waveguide portion 602, a taper portion 604, and a tip portion 606. In some embodiments, taper portions 614 and 604 and tip portions 616 and 606 may be considered an optical spot-size coupler structure that optically couples first optical waveguide structure 412 (e.g., including waveguide portion 612) to second optical waveguide structure 404 (e.g., including waveguide portion 602). Also, in some embodiments, at least a portion of tip portions 606 and 612 may overlap to form the corresponding optical spot-size coupler structure, as illustrated in FIGS. 5A and 5B.

For example, FIG. 6A illustrates a first optical waveguide structure 412A and a corresponding second optical waveguide structure 404A that employ a contiguous structure. More specifically, first optical waveguide structure 412A may be a single-thickness contiguous structure 412B, a two-step thickness contiguous structure 412C, or a three-step thickness contiguous structure 412D, and second optical waveguide structure 404B may be a single-thickness contiguous structure 404B, a two-step thickness contiguous structure 404C, or a three-step thickness contiguous structure 404D.

FIG. 6B illustrates a first optical waveguide structure 412E and a corresponding second optical waveguide structure 404E that employ a sub-wavelength grating (SWG) structure in both taper sections 614 and 604 and tip sections 616 and 606. In some embodiments, an SWG structure may include a plurality of gratings of constant width and constant spacing. Moreover, first optical waveguide structure 412E may be a single-thickness SWG structure 412F, a two-step thickness SWG structure 412G, or a three-step thickness SWG structure 412H, and second optical waveguide structure 404E may be a single-thickness SWG structure 404F, a two-step thickness SWG structure 404G, or a three-step thickness SWG structure 404H.

FIG. 6C illustrates a first optical waveguide structure 412I and a corresponding second optical waveguide structure 404I that employ an SWG structure in tip sections 616 and 606 alone. Moreover, first optical waveguide structure 412I may be a single-thickness SWG structure 412J, a two-step thickness SWG structure 412K, or a three-step thickness SWG structure 412L, and second optical waveguide structure 404I may be a single-thickness SWG structure 404J, a two-step thickness SWG structure 404K, or a three-step thickness SWG structure 404L.

FIG. 6D illustrates a first optical waveguide structure 412M and a corresponding second optical waveguide structure 404M that employ an apodized SWG structure in both taper sections 614 and 604 and tip sections 616 and 606. In some embodiments, an apodized SWG structure may having a plurality of gratings of varying width and/or spacing. Further, first optical waveguide structure 412M may be a single-thickness apodized SWG structure 412N, a two-step thickness apodized SWG structure 412O, or a three-step thickness apodized SWG structure 412P, and second optical waveguide structure 404M may be a single-thickness apodized SWG structure 404N, a two-step thickness apodized SWG structure 404O, or a three-step thickness apodized SWG structure 404P.

FIG. 6E illustrates a first optical waveguide structure 412Q and a corresponding second optical waveguide structure 404Q that employ an apodized SWG structure in tip sections 616 and 606 alone. Further, first optical waveguide structure 412Q may be a single-thickness apodized SWG structure 412R, a two-step thickness apodized SWG structure 412S, or a three-step thickness apodized SWG structure 412T, and second optical waveguide structure 404Q may be a single-thickness apodized SWG structure 404R, a two-step thickness apodized SWG structure 404S, or a three-step thickness apodized SWG structure 404T.

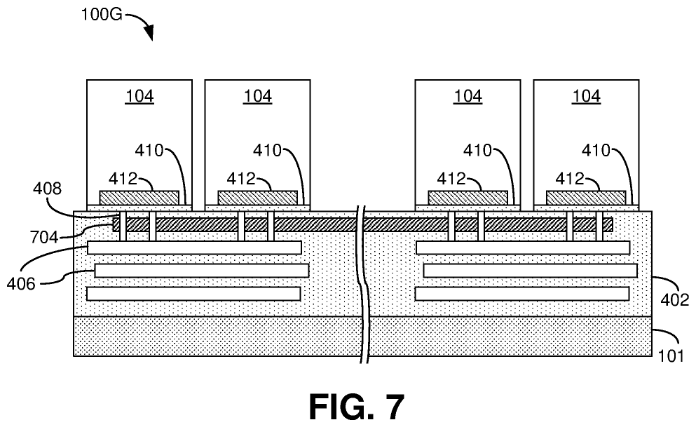

FIG. 7 illustrates a cross-sectional view of some embodiments of a 2.5D SoC device 100G including another optical waveguide structure 704 in a dielectric layer 402 between a plurality of IC dies 104 and an interposer structure 101, according to the present disclosure. In some embodiments, SoC device 100G is configured substantially as SoC device 100F of FIG. 4, except that second optical waveguide structure 704 (e.g., a waveguide structure including polycrystalline silicon) may be utilized in place of second optical waveguide structure 404 (e.g., a waveguide structure including silicon nitride (SiN)) in dielectric layer 402.

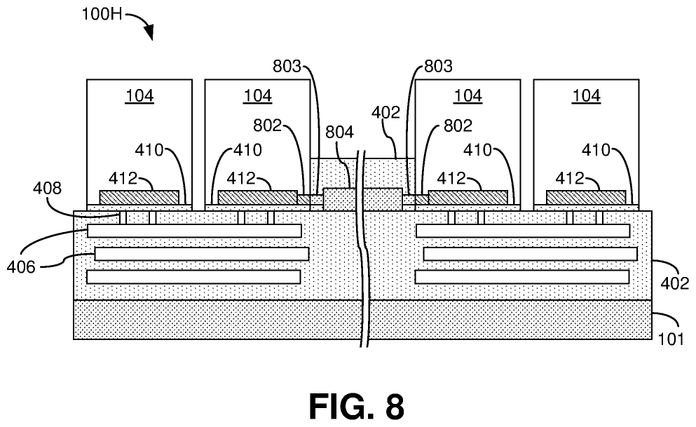

FIGS. 8 through 12 illustrate cross-sectional views of some embodiments of 2.5D SoC devices 100H through 100L, respectively, including an optical waveguide structure in a second dielectric layer 402 laterally disposed among a plurality of IC dies 104 (e.g., in interstices among IC dies 104) and over an interposer structure 101, according to the present disclosure. For example, FIG. 8 illustrates a cross-sectional view of a 2.5D SoC device 100H in which at least a first IC die 104 and a second IC die 104 include a first optical waveguide structure 412 (e.g., a silicon (Si) waveguide) coupled to a first optical edge coupler structure 802 (e.g., a silicon (Si) edge coupler) that is located at a side surface of the corresponding IC die 104.

In some embodiments, a first dielectric layer 402 disposed over interposer structure 101 may include conductive structures 406 and conductive vias 408, as described above in conjunction with FIG. 4.

In addition, in some embodiments, a second dielectric layer 402 located over first dielectric layer 402 and disposed laterally among the plurality of IC dies 104 may include a second optical waveguide structure 804 (e.g., a polymer waveguide, which may include a polyaccrylate, a polyimide, polymethyl methacrylate (PMMA), or the like) and second and third optical edge coupler structures 803 (e.g., polymer edge couplers) coupling second optical waveguide structure 804 to first optical edge coupler structures 802 of first and second IC dies 104. Consequently, an E-O signal converter (not shown in FIG. 8) may provide an optical signal to first optical waveguide structure 412 of first IC die 104 for transmission, in turn, over first optical edge coupler structure 802 of first IC die 104, second optical edge coupler structure 803, second optical waveguide structure 804, third optical edge coupler structure 803, first optical edge coupler structure 802 of second IC die 104, and first optical waveguide structure 412 of first IC die 104 to an O-E signal converter in second IC die 104 (not depicted in FIG. 8).

While second optical waveguide structure 804 is shown in FIG. 8 as a single linear portion, in other embodiments, second optical waveguide structure 804 may include one or more bends to form a non-linear path (e.g., along rows or columns of IC dies 104) while remaining within interstices among IC dies 104.

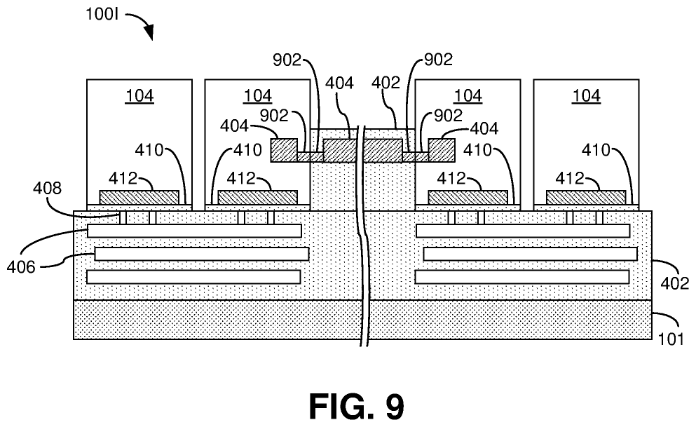

FIG. 9 illustrates a cross-sectional view of a 2.5D SoC device 100I in which at least a first IC die 104 and a second IC die 104 include a first optical waveguide structure 404 (e.g., a silicon nitride (SiN) waveguide) coupled to a first optical edge coupler structure 902 (e.g., a silicon nitride (SiN) edge coupler) that is located at a side surface of the corresponding IC die 104.

Along with a first dielectric layer 402 disposed over interposer structure 101, as described above in conjunction with FIG. 8, a second dielectric layer 402 located over first dielectric layer 402 and disposed laterally among the plurality of IC dies 104 may include a second optical waveguide structure 404 (e.g., a silicon nitride (SiN) waveguide) and second and third optical edge coupler structures 902 (e.g., silicon nitride (SiN) edge couplers) coupling second optical waveguide structure 404 to first optical edge coupler structures 902 of first and second IC dies 104. Further, in some embodiments, each of first and second IC dies 104 may include an internal optical waveguide structure 412 (e.g., a silicon (Si) waveguide structure), similar to those described above, to internally couple to first optical waveguide structure 404, in a manner as shown in FIGS. 6A through 6E. Consequently, an E-O signal converter (not shown in FIG. 9) may provide an optical signal to internal first optical waveguide structure 412 of first IC die 104 for transmission, in turn, over first optical waveguide structure 404 of first IC die 104, first optical edge coupler structure 902 of first IC die 104, second optical edge coupler structure 902, second optical waveguide structure 404, third optical edge coupler structure 902, first optical edge coupler structure 902 of second IC die 104, first optical waveguide structure 404 of second IC die 104, and internal optical waveguide structure 412 of second IC die 104 to an O-E signal converter in second IC die 104 (also not depicted in FIG. 9).

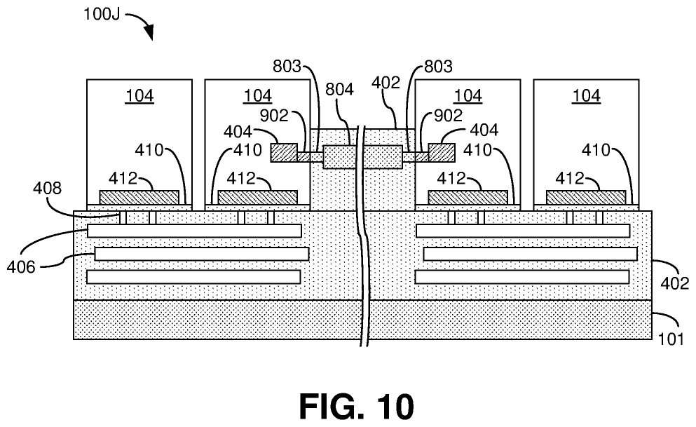

FIG. 10 illustrates a cross-sectional view of a 2.5D SoC device 100J that provides the same configuration as SoC device 100I of FIG. 9, with the exception of employing a second optical waveguide structure 804 (e.g., a polymer waveguide) and second and third optical edge coupler structures 803 (e.g., polymer edge couplers) coupling second optical waveguide structure 804 to first optical edge coupler structures 902 of first and second IC dies 104.

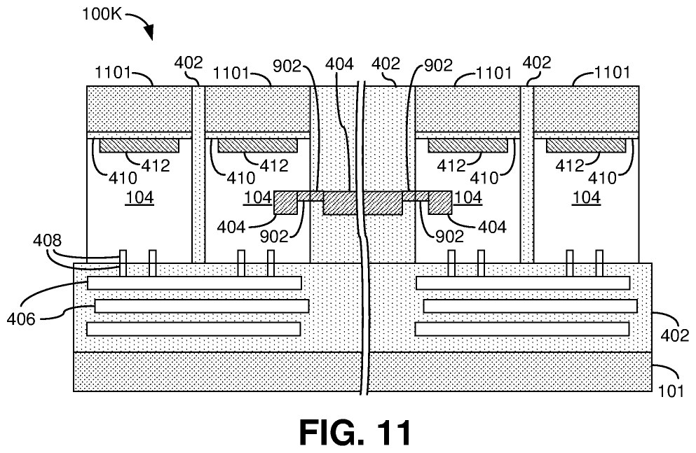

FIG. 11 illustrates a cross-sectional view of a 2.5D SoC device 100K in which IC dies 104 are inverted (e.g., in a flip-chip configuration) relative to those depicted, for example, in FIG. 9. In some embodiments, each die 104 may include a substrate 1101 (e.g., a silicon (Si) substrate) to a proximal surface of die 104 relative to first dielectric layer 402. Moreover, in some embodiments, first and second dies 104 may include initial optical waveguide structure 412, first optical waveguide structure 404, and first optical edge coupler structure 902, and second dielectric layer 402 may include second optical edge coupler structure 902, second optical waveguide structure 404, and third optical edge coupler structure 902 (e.g., in an inverted orientation relative to the corresponding features of SoC device 100I of FIG. 9). Also, in some embodiments, second dielectric layer 402 may extend upward to a height of each IC die 104. Additionally, in some embodiments, substrate 1101 of each IC die 104 may not be thinned, as heat removal and signal access may not be of concern in the configuration of SoC device 100K of FIG. 11.

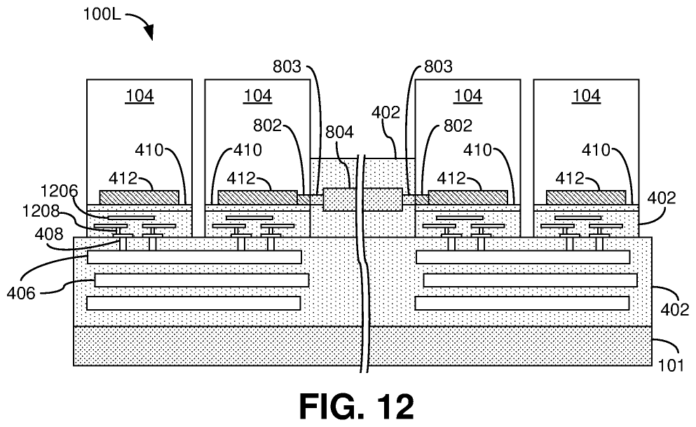

FIG. 12 illustrates a cross-sectional view of a 2.5D SoC device 100L. In some embodiments, IC dies 104 may be configured in a manner similar to that of FIGS. 4 and 7, with the addition of a backside conductive interconnect structure that may include conductive layers 1206 and associated vias 1208 in a dielectric layer 402. Such a backside conductive interconnect structure may provide electrical connectivity for circuitry within IC die 104 to conductive structures 406 and conductive vias 408 of first dielectric layer 402 for connection with nearby IC dies 104.

Further, in some embodiments, at least first and second dies 104 may include first optical waveguide structures 412 (e.g., silicon (Si) waveguides) and first optical edge coupler structures 802 (e.g., silicon (Si) edge couplers), and a second dielectric layer 402 disposed over first dielectric layer 402 and positioned laterally among dies 104 may include a second optical waveguide structure 804 (e.g., a polymer waveguide) and second and third optical edge coupler structures 803 (e.g., polymer edge couplers) coupling second optical waveguide structure 804 to first optical edge coupler structures 802 of first and second IC dies 104, as set forth in FIG. 8.

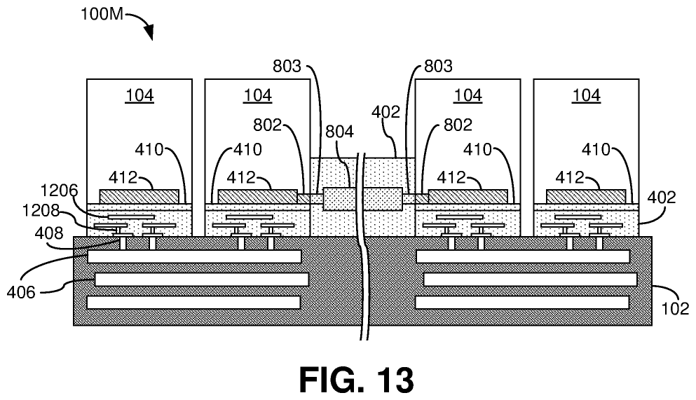

FIG. 13 illustrates a cross-sectional view of some embodiments of a 2.5D SoC device 100M including an optical waveguide structure 804 in a dielectric layer 402 among a plurality of IC dies 104 and over a package substrate structure 102, according to the present disclosure. In some embodiments, package substrate structure 102 may include, for example, organic, ceramic, and/or semiconductor materials. Further, in some embodiments, package substrate structure 102 may include conductive structures 406 and conductive vias 408 for electrical interconnection of IC dies 104, as described above in connection with interposer structure 101.

Additionally, in some embodiments, at least first and second IC dies 104 may include first optical waveguide structures 412 (e.g., silicon (Si) waveguides) and first optical edge coupler structures 802 (e.g., silicon (Si) edge couplers), and a second dielectric layer 402 disposed over package substrate structure 102 and disposed laterally among dies 104 may include a second optical waveguide structure 804 (e.g., a polymer waveguide) and second and third optical edge coupler structures 803 (e.g., polymer edge couplers) coupling second optical waveguide structure 804 to first optical edge coupler structures 802 of first and second IC dies 104, as set forth in FIGS. 8 and 12, as discussed above.

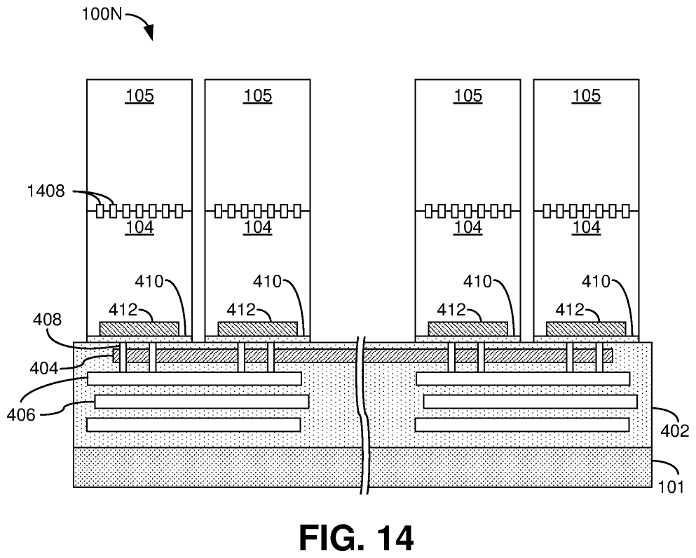

FIG. 14 illustrates a cross-sectional view of some embodiments of a 3D SoC device 100N including an optical waveguide structure 404 in a dielectric layer between a plurality of IC dies 104 and an interposer structure 101, according to the present disclosure, as described above in conjunction with FIG. 4. In addition, a second layer of IC dies 105 may be included, in which each IC die 105 is bonded (e.g., via heat-based bonding of dielectric layers (not explicitly shown in FIG. 14) and associated conductive contacts 1408, or by microbumps (e.g., small solder bumps)) to a corresponding IC die 104. Further, in some embodiments, IC dies 105 may be inverted relative to IC dies 104 to facilitate bonding therebetween at an upper surface of each of IC dies 104 and 104. In some embodiments, each IC die 105 may communicate with other IC dies of SoC device 100N by way of the electrical connections provided between IC die 105 and the IC die 104 to which IC die 105 is directly bonded.

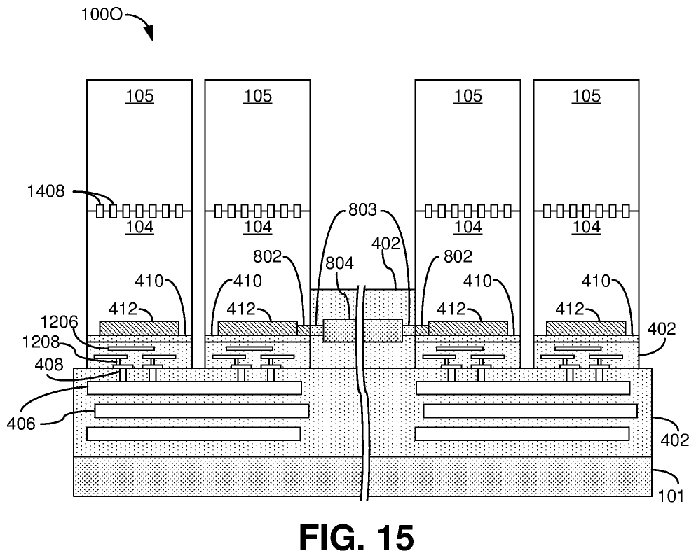

FIG. 15 illustrates a cross-sectional view of some embodiments of a 3D SoC device 100O including an optical waveguide structure 804 in a dielectric layer 402 among a plurality of IC dies 104 and over an interposer structure 101, according to the present disclosure. In some embodiments, the configuration of SoC device 100O matches the configuration of SoC device 100L of FIG. 12, with the exception of an added layer of IC dies 105 bonded to IC dies 104 via conductive contacts 1408 or microbumps, as discussed above in conjunction with SoC device 100N of FIG. 14.

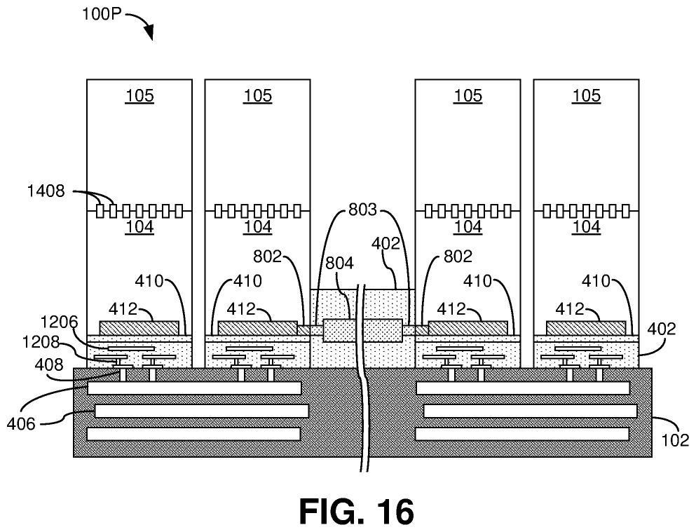

FIG. 16 illustrates a cross-sectional view of some embodiments of a 3D SoC device 100P including an optical waveguide structure 804 in a dielectric layer 402 among a plurality of IC dies 104 and over a package substrate structure 102, according to the present disclosure. In some embodiments, the configuration of SoC device 100P matches the configuration of SoC device 100M of FIG. 12, with the exception of an added layer of IC dies 105 bonded to IC dies 104 via conductive contacts 1408 or microbumps, as discussed above in conjunction with SoC device 100N of FIG. 14.

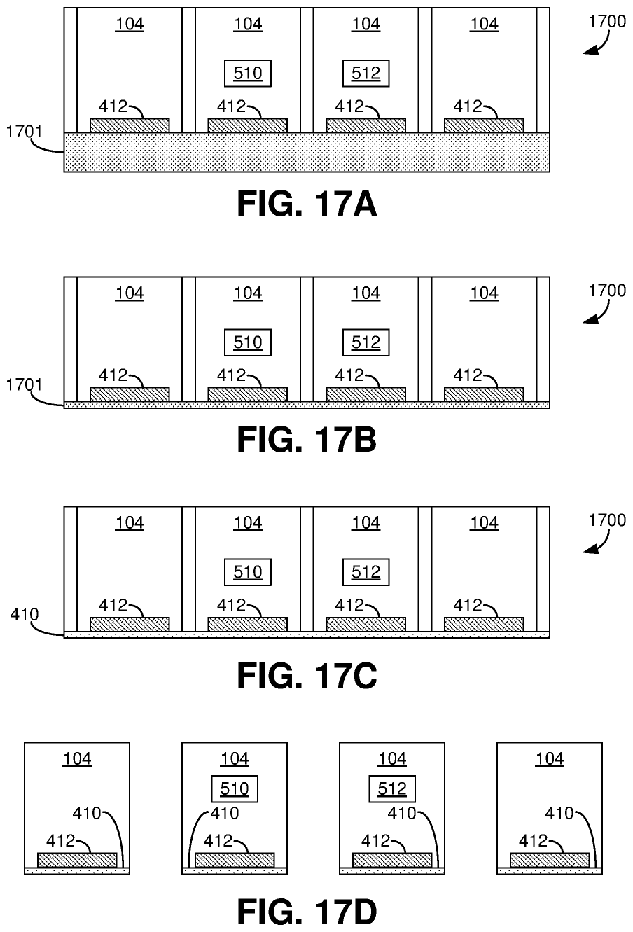

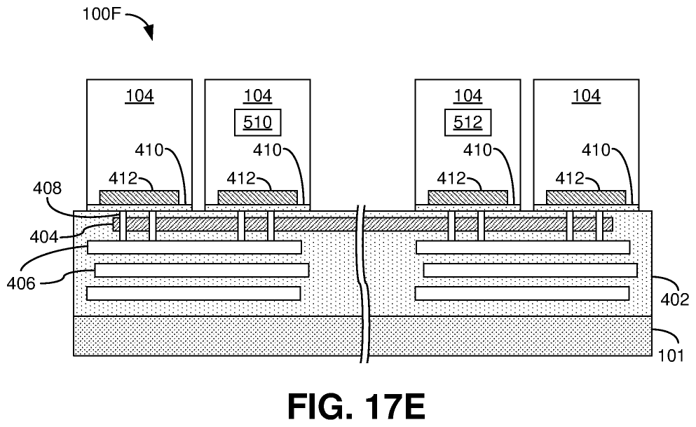

FIGS. 17A through 17E illustrate cross-sectional views of some embodiments of an SoC device 100F, as discussed above in connection with FIG. 4, at multiple stages of fabrication, according to the present disclosure. Although FIGS. 17A through 17E are described as a series of acts, it will be appreciated that these acts are not limiting in that the order of the acts within each series can be altered in other embodiments, and the methods disclosed are also applicable to other structures. In other embodiments, some acts that are illustrated and/or described may be omitted in whole or in part.

For example, FIG. 17A illustrates a wafer 1700 including a substrate 1701 (e.g., a semiconductor (e.g., silicon (Si)) substrate) over which structures for a plurality of IC dies 104 are disposed. Each of at least first and second IC dies 104 may include a first optical waveguide structure 412 (e.g., a silicon (Si) waveguide) formed (e.g., deposited) over substrate 1701. Also, formed in wafer 1700 may be an E-O signal converter 510 coupled to a first optical waveguide structure 412 in at least first IC die 104 and an O-E signal converter 512 coupled to another first optical waveguide structure 412 in at least second IC die 104.

FIG. 17B illustrates the thinning (e.g., grinding) of a lower surface (e.g., a backside) of substrate 1701 to reduce an overall height of SoC device 100F, as well as provide electrical and optical access, as well as heat dissipation, to dies 104 from below.

FIG. 17C illustrates the forming (e.g., growth or regrowth) of an oxide layer 410 (e.g., silicon oxide (SiOₓ), such as silicon dioxide (SiO₂), or another oxide or dielectric material) at substrate 1701. Thereafter, FIG. 17D illustrates the separating (e.g., singulation) of wafer 1700 into individual IC dies 104.

FIG. 17E illustrates the forming (e.g., bonding, such as heat-based bonding) of IC dies 104 onto a dielectric layer 402 disposed over an interposer structure 101. In some embodiments, conductive contacts along a lower surface of each IC die 104 and corresponding contacts along an upper surface of dielectric layer 402 may be bonded together, as well as oxide layer 410 and the upper surface of dielectric layer, by way of the bonding operation, as indicated in FIG. 5B.

In some embodiments, dielectric layer 402 may include a second optical waveguide structure 404 (e.g., a waveguide structure including silicon nitride (SiN)) that is optically coupled to first optical waveguide structure 412 of first and second IC dies 104. In some embodiments, first optical waveguide structure 412 and second optical waveguide structure 404 may be optically coupled by way of optical spot-size coupler structures (e.g., as the widths of first optical waveguide structure 412 and second optical waveguide structure 404 may be different), as discussed above in conjunction with FIGS. 6A through 6E.

Further, dielectric layer 402 may include conductive structures 406 (e.g., layers or wires of metal (e.g., copper (Cu)) or an alloy), one or more of which may be connected to IC die 104 by way of conductive vias 408 to surface contact structures (not depicted in FIG. 17E) bridging the lower surface of IC die 104 and the upper surface of dielectric layer 402 (by way of bonding IC die 104 to dielectric layer 402).

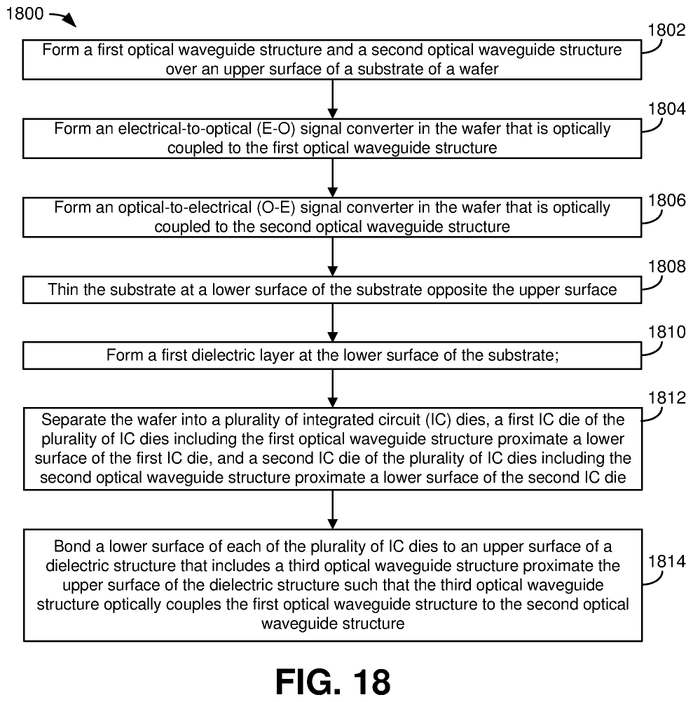

FIG. 18 illustrates some embodiments of a methodology 1800 of forming SoC device 100F of FIGS. 17A through 17E, in accordance with the present disclosure. Although this method and other methods illustrated and/or described herein are illustrated as a series of acts or events, it will be appreciated that the present disclosure is not limited to the illustrated ordering or acts. Thus, in some embodiments, the acts may be carried out in different orders than illustrated, and/or may be carried out concurrently. Further, in some embodiments, the illustrated acts or events may be subdivided into multiple acts or events, which may be carried out at separate times or concurrently with other acts or sub-acts. In some embodiments, some illustrated acts or events may be omitted, and other un-illustrated acts or events may be included.

At Act 1802, for example, a first optical waveguide structure and a second optical waveguide structure (e.g., first optical waveguide structures 412 of FIG. 17A) are formed over an upper surface of a substrate (e.g., substrate 1701 of FIG. 17A) of a wafer (e.g., wafer 1700 of FIG. 17A). At Act 1804, an electrical-to-optical (E-O) signal converter (e.g., E-O signal converter 510 of FIG. 17A) is formed in the wafer that is optically coupled to the first optical waveguide structure. At Act 1806, an optical-to-electrical (O-E) signal converter (e.g., O-E signal converter 512 of FIG. 17A) is formed in the wafer that is optically coupled to the second optical waveguide structure. FIG. 17A illustrates a cross-sectional view of some embodiments corresponding to Acts 1802, 1804, and 1806.

At Act 1808, the substrate may be thinned at a lower surface of the substrate opposite the upper surface. FIG. 17C illustrates a cross-sectional view of some embodiments corresponding to Act 1808.

At Act 1810, a first dielectric layer (e.g., oxide layer 410 of FIG. 17C) may be formed at the lower surface of the substrate. FIG. 17C illustrates a cross-sectional view of some embodiments corresponding to Act 1810.

At Act 1812, the wafer may be separated into a plurality of integrated circuit (IC) dies (e.g., IC dies 104 of FIG. 17D). In some embodiments, a first IC die of the plurality of IC dies may include the first optical waveguide structure proximate a lower surface of the first IC die, and a second IC die of the plurality of IC dies may include the second optical waveguide structure proximate a lower surface of the second IC die. FIG. 17D illustrates a cross-sectional view of some embodiments corresponding to Act 1812.

At Act 1814, a lower surface of each of the plurality of IC dies may be bonded to an upper surface of a dielectric structure (e.g., dielectric layer 402 of FIG. 17E) that includes a third optical waveguide structure (e.g., second optical waveguide structure 404 of FIG. 17E) proximate the upper surface of the dielectric structure such that the third optical waveguide structure optically couples the first optical waveguide structure to the second optical waveguide structure. FIG. 17E illustrates a cross-sectional view of some embodiments corresponding to Act 1814.

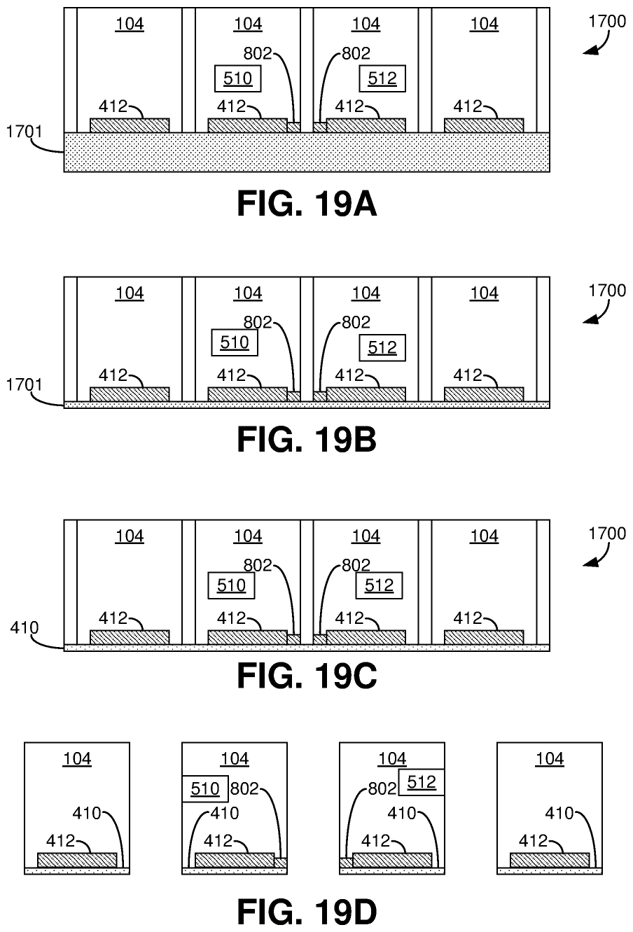

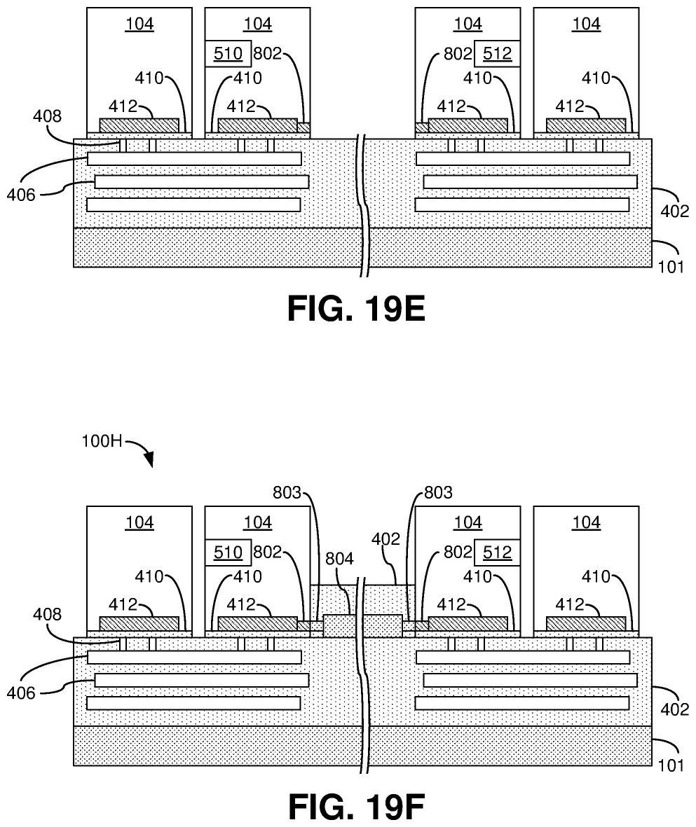

FIGS. 19A through 19F illustrate cross-sectional views of some embodiments of an SoC device 100H, as discussed above in connection with FIG. 8, at multiple stages of fabrication, according to the present disclosure. Although FIGS. 19A through 19F are described as a series of acts, it will be appreciated that these acts are not limiting in that the order of the acts within each series can be altered in other embodiments, and the methods disclosed are also applicable to other structures. In other embodiments, some acts that are illustrated and/or described may be omitted in whole or in part.

For example, FIG. 19A illustrates a wafer 1700 including a substrate 1701 (e.g., a semiconductor (e.g., silicon (Si)) substrate) over which structures for a plurality of IC dies 104 are disposed. Each of at least first and second IC dies 104 may include a first optical waveguide structure 412 (e.g., a silicon (Si) waveguide) formed (e.g., deposited) over substrate 1701. Also, formed in wafer 1700 may be an E-O signal converter 510 coupled to a first optical waveguide structure 412 in at least first IC die 104 and an O-E signal converter 512 coupled to another first optical waveguide structure 412 in at least second IC die 104. Further, in some embodiments, each of first and second IC dies 104 may also include a first optical edge coupler structure 802 that is optically coupled to a corresponding first optical waveguide structure 412.

FIG. 19B illustrates the thinning (e.g., grinding) of a lower surface (e.g., a backside) of substrate 1701 to reduce an overall height of SoC device 100H, as well as provide electrical and optical access to dies 104 from below.

FIG. 19C illustrates the forming (e.g., growth or regrowth) of an oxide layer 410 (e.g., silicon oxide (SiOₓ), such as silicon dioxide (SiO₂), or another oxide or dielectric material) at substrate 1701. Thereafter, FIG. 19D illustrates the separating (e.g., singulation) of wafer 1700 into individual IC dies 104.

FIG. 19E illustrates the forming (e.g., bonding, such as heat-based bonding) of IC dies 104 onto a first dielectric layer 402 disposed over an interposer structure 101. In some embodiments, conductive contacts along a lower surface of each IC die 104 and corresponding contacts along an upper surface of dielectric layer 402 may be bonded together, as well as oxide layer 410 and the upper surface of dielectric layer, by way of the bonding operation, as indicated in FIG. 5B.

In some embodiments, first dielectric layer 402 may include conductive structures 406 (e.g., layers or wires of metal (e.g., copper (Cu)) or an alloy), one or more of which may be connected to IC die 104 by way of conductive vias 408 to surface contact structures (not depicted in FIG. 19E) bridging the lower surface of IC die 104 and the upper surface of dielectric layer 402 (by way of bonding IC die 104 to dielectric layer 402).

FIG. 19F illustrates the forming (e.g., etching and deposition) of a second dielectric layer 402 over first dielectric layer 402 (e.g., in lateral interstices among at least some of IC dies 104). Further, in some embodiments, a second optical waveguide structure 804 (e.g., a waveguide structure including a polymer) and second and third optical edge coupler structures 803 (e.g., edge couplers that include a polymer) optically coupled to second optical waveguide structure 804 may be formed in second dielectric layer 402. In addition, in some embodiments, second and third optical edge coupler structures 803 may be optically coupled to first optical edge coupler structure 802 of first and second IC dies such that first optical waveguide structures 412 may be optically coupled to each other by way of first optical edge coupler structures 802, second and third optical edge coupler structures 803, and second optical waveguide structure 804.

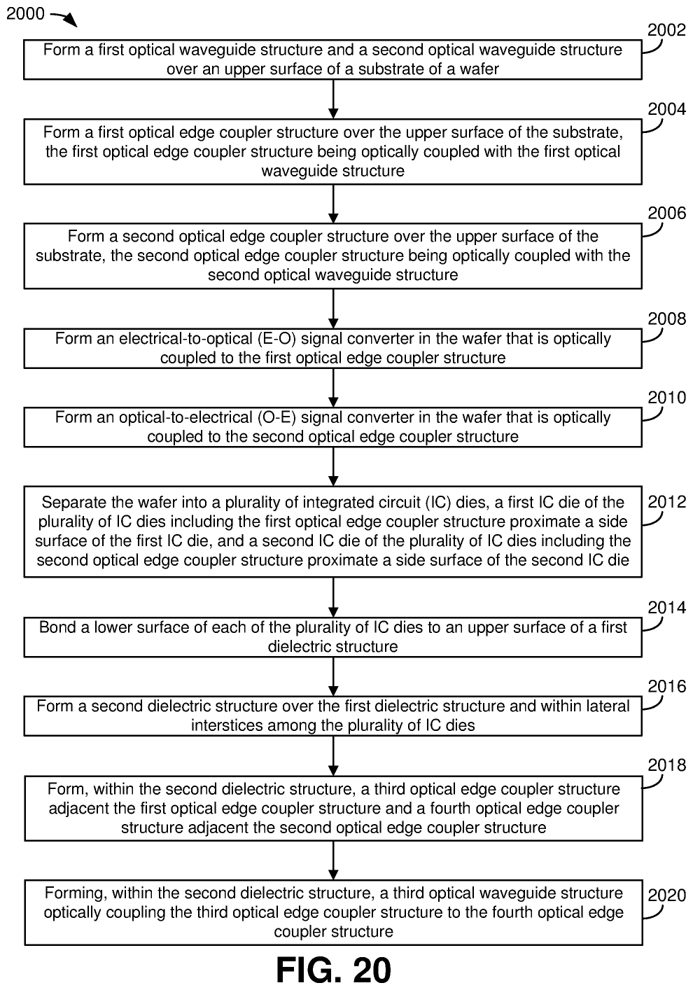

FIG. 20 illustrates some embodiments of a methodology 2000 of forming SoC device 100H of FIGS. 19A through 19F, in accordance with the present disclosure. Although this method and other methods illustrated and/or described herein are illustrated as a series of acts or events, it will be appreciated that the present disclosure is not limited to the illustrated ordering or acts. Thus, in some embodiments, the acts may be carried out in different orders than illustrated, and/or may be carried out concurrently. Further, in some embodiments, the illustrated acts or events may be subdivided into multiple acts or events, which may be carried out at separate times or concurrently with other acts or sub-acts. In some embodiments, some illustrated acts or events may be omitted, and other un-illustrated acts or events may be included.

At Act 2002, for example, a first optical waveguide structure and a second optical waveguide structure (e.g., first optical waveguide structures 412 of first and second IC dies 104 of FIG. 19A) are formed over an upper surface of a substrate (e.g., substrate 1701 of FIG. 19A) of a wafer (e.g., wafer 1700 of FIG. 19A). At Act 2004, a first optical edge coupler structure (e.g., first optical edge coupler structure 802 of first IC die 104 of FIG. 19A) is formed over the upper surface of the substrate, where the first optical edge coupler is optically coupled with the first optical waveguide structure. At Act 2006, a second optical edge coupler structure (e.g., first optical edge coupler structure 802 of second IC die 104 of FIG. 19A) is formed over the upper surface of the substrate, where the second optical edge coupler is optically coupled with the second optical waveguide structure. At Act 2008, an electrical-to-optical (E-O) signal converter (e.g., E-O signal converter 510 of FIG. 19A) is formed in the wafer that is optically coupled to the first optical waveguide structure. At Act 2010, an optical-to-electrical (O-E) signal converter (e.g., O-E signal converter 512 of FIG. 19A) is formed in the wafer that is optically coupled to the second optical waveguide structure. FIG. 19A illustrates a cross-sectional view of some embodiments corresponding to Acts 2002, 2004, 2006, 2008, and 2010. Additionally, in some embodiments, the substrate may be thinned at a lower surface of the substrate opposite the upper surface (e.g., as shown in FIG. 19B), and a first dielectric layer (e.g., oxide layer 410 of FIG. 19C) may be formed at the lower surface of the substrate (e.g., as illustrated in FIG. 19C).

At Act 2012, the wafer may be separated into a plurality of integrated circuit (IC) dies (e.g., IC dies 104 of FIG. 19D). In some embodiments, a first IC die of the plurality of IC dies may include the first optical edge coupler structure proximate a side surface of the first IC die, and a second IC die of the plurality of IC dies may include the second optical edge coupler structure proximate a side surface of the second IC die. FIG. 19D illustrates a cross-sectional view of some embodiments corresponding to Act 2012.

At Act 2014, a lower surface of each of the plurality of IC dies may be bonded to an upper surface of a first dielectric structure (e.g., first dielectric layer 402 of FIG. 19E). FIG. 19E illustrates a cross-sectional view of some embodiments corresponding to Act 2014.

At Act 2016, a second dielectric structure (e.g., second dielectric layer 402 of FIG. 19F) may be formed over the first dielectric structure and within lateral interstices among the plurality of IC dies. At Act 2018, a third optical edge coupler structure (e.g., second optical edge coupler structure 803 of FIG. 19F) is formed within the second dielectric structure adjacent the first optical edge coupler structure, and a fourth optical edge coupler structure (e.g., third optical edge coupler edge coupler structure 803 of FIG. 19F) is formed within the second dielectric structure adjacent the second optical edge coupler structure. At Act 2020, a third optical waveguide structure (e.g., second optical waveguide structure 804 of FIG. 19E) is formed within the second dielectric structure to optically couple the third optical edge coupler structure to the fourth optical edge coupler structure. FIG. 19F illustrates a cross-sectional view of some embodiments corresponding to Acts 2016, 2018, and 2020.

Some embodiments relate to an integrated circuit (IC) device. The device includes: a substrate structure; a dielectric structure adjacent the substrate structure; a plurality of dies disposed over the substrate structure, the plurality of dies including: a first die including a first optical waveguide structure; and a second die including a second optical waveguide structure; and a third optical waveguide structure disposed in the dielectric structure and external to the plurality of dies, the third optical waveguide structure optically coupling the first optical waveguide structure to the second optical waveguide structure.

Some embodiments relate to a method. The method includes: forming a first optical waveguide structure and a second optical waveguide structure over an upper surface of a substrate of a wafer; forming an electrical-to-optical (E-O) signal converter in the wafer that is optically coupled to the first optical waveguide structure; forming an optical-to-electrical (O-E) signal converter in the wafer that is optically coupled to the second optical waveguide structure; thinning the substrate at a lower surface of the substrate opposite the upper surface; forming a first dielectric layer at the lower surface of the substrate; separating the wafer into a plurality of dies, a first die of the plurality of dies including the first optical waveguide structure proximate a lower surface of the first die, and a second die of the plurality of dies including the second optical waveguide structure proximate a lower surface of the second die; and bonding a lower surface of each of the plurality of dies to an upper surface of a dielectric structure that includes a third optical waveguide structure proximate the upper surface of the dielectric structure such that the third optical waveguide structure optically couples the first optical waveguide structure to the second optical waveguide structure.

Some embodiments relate to another IC device. The IC device includes: a substrate structure; a dielectric structure adjacent the substrate structure; a plurality of dies disposed over the substrate structure, the plurality of dies comprising: a first die comprising a first optical waveguide structure and a first contact structure; and a second die comprising a second optical waveguide structure and a second contact structure; a third optical waveguide structure disposed in the dielectric structure and external to the plurality of dies, the third optical waveguide structure optically coupling the first optical waveguide structure to the second optical waveguide structure; and a first conductive via, a second conductive via, and a conductive structure disposed in the dielectric structure and external to the plurality of dies, the first conductive via electrically coupled to the first contact structure, the second conductive via electrically coupled to the second contact structure, and the conductive structure electrically coupling the first conductive via to the second conductive via.

It will be appreciated that in this written description, as well as in the claims below, the terms “first”, “second”, “second”, “third” etc. are merely generic identifiers used for ease of description to distinguish between different elements of a figure or a series of figures. In and of themselves, these terms do not imply any temporal ordering or structural proximity for these elements, and are not intended to be descriptive of corresponding elements in different illustrated embodiments and/or un-illustrated embodiments. For example, “a first dielectric layer” described in connection with a first figure may not necessarily correspond to a “first dielectric layer” described in connection with another figure, and may not necessarily correspond to a “first dielectric layer” in an un-illustrated embodiment.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit (IC) device, comprising:
a substrate structure;
a dielectric structure adjacent the substrate structure;
a plurality of dies disposed over the substrate structure, the plurality of dies comprising:
a first die comprising a first optical waveguide structure; and
a second die comprising a second optical waveguide structure; and
a third optical waveguide structure disposed in the dielectric structure and external to the plurality of dies, the third optical waveguide structure optically coupling the first optical waveguide structure to the second optical waveguide structure.

2. The IC device of claim 1, wherein the dielectric structure is disposed between the substrate structure and the plurality of dies.

3. The IC device of claim 2, wherein the third optical waveguide structure is disposed under the first die, the second die, and at least a third die of the plurality of dies.

4. The IC device of claim 2, wherein:
the first die further comprises a first optical spot-size coupler structure optically coupled to the first optical waveguide structure;
the second die further comprises a second optical spot-size coupler structure optically coupled to the second optical waveguide structure; and
the dielectric structure further comprises:
a third optical spot-size coupler structure optically coupled to a first end of the third optical waveguide structure and the first optical spot-size coupler structure and disposed below the first die; and
a fourth optical spot-size coupler structure optically coupled to a second end of the third optical waveguide structure and the second optical spot-size coupler structure and disposed below the second die.

5. The IC device of claim 4, wherein the first optical spot-size coupler structure and the first optical waveguide structure combine to form one of a single-thickness structure, a two-step-thickness structure, or a three-step-thickness structure.

6. The IC device of claim 4, wherein the first optical spot-size coupler structure comprises a constant sub-wavelength-grating.

7. The IC device of claim 4, wherein the first optical spot-size coupler structure comprises an apodized sub-wavelength-grating.

8. The IC device of claim 2, wherein:
the first optical waveguide structure and the second optical waveguide structure comprise silicon; and
the third optical waveguide structure comprises silicon nitride.

9. The IC device of claim 2, wherein:
the first optical waveguide structure and the second optical waveguide structure comprise silicon; and
the third optical waveguide structure comprises polycrystalline silicon.

10. The IC device of claim 1, wherein the substrate structure comprises an interposer structure.

11. The IC device of claim 1, wherein the dielectric structure is disposed over the substrate structure and laterally among the plurality of dies.

12. The IC device of claim 11, wherein:
the first die further comprises a first optical edge coupler structure optically coupled to the first optical waveguide structure; and
the second die further comprises a second optical edge coupler structure optically coupled to the second optical waveguide structure; and
the dielectric structure further comprises:
a third optical edge coupler structure optically coupled to a first end of the third optical waveguide structure and the first optical edge coupler structure; and
a fourth optical edge coupler structure optically coupled to a second end of the third optical waveguide structure and the second optical edge coupler structure.

13. The IC device of claim 11, wherein the third optical waveguide structure is routed laterally within interstices among the plurality of dies.

14. The IC device of claim 11, wherein:
the first optical waveguide structure and the second optical waveguide structure comprise one of silicon or silicon nitride; and
the third optical waveguide structure comprises a polymer.

15. The IC device of claim 11, wherein:
the first optical waveguide structure, the second optical waveguide structure, and the third optical waveguide structure comprise silicon nitride.

16. The IC device of claim 11, wherein the substrate structure comprises one of an interposer structure or a package substrate structure.

17. The IC device of claim 1, wherein:
the first die further comprises an electrical-to-optical (E-O) signal converter optically coupled to the first optical waveguide structure; and
the second die comprises an optical-to-electrical (O-E) signal converter optically coupled to the second optical waveguide structure.

18. A method, comprising:
forming a first optical waveguide structure and a second optical waveguide structure over an upper surface of a substrate of a wafer;
forming an electrical-to-optical (E-O) signal converter in the wafer that is optically coupled to the first optical waveguide structure;
forming an optical-to-electrical (O-E) signal converter in the wafer that is optically coupled to the second optical waveguide structure;
thinning the substrate at a lower surface of the substrate opposite the upper surface;
forming a first dielectric layer at the lower surface of the substrate;
separating the wafer into a plurality of dies, a first die of the plurality of dies comprising the first optical waveguide structure proximate a lower surface of the first die, and a second die of the plurality of dies comprising the second optical waveguide structure proximate a lower surface of the second die; and
bonding a lower surface of each of the plurality of dies to an upper surface of a dielectric structure that includes a third optical waveguide structure proximate the upper surface of the dielectric structure such that the third optical waveguide structure optically couples the first optical waveguide structure to the second optical waveguide structure.

19. The method of claim 18, wherein, after bonding the lower surface of each of the plurality of dies to the upper surface of the dielectric structure, a portion of the third optical waveguide structure is disposed below a third die of the plurality of dies.

20. An integrated circuit (IC) device, comprising:
a substrate structure;
a dielectric structure adjacent the substrate structure;
a plurality of dies disposed over the substrate structure, the plurality of dies comprising:
a first die comprising a first optical waveguide structure and a first contact structure; and
a second die comprising a second optical waveguide structure and a second contact structure;
a third optical waveguide structure disposed in the dielectric structure and external to the plurality of dies, the third optical waveguide structure optically coupling the first optical waveguide structure to the second optical waveguide structure; and
a first conductive via, a second conductive via, and a conductive structure disposed in the dielectric structure and external to the plurality of dies, the first conductive via electrically coupled to the first contact structure, the second conductive via electrically coupled to the second contact structure, and the conductive structure electrically coupling the first conductive via to the second conductive via.
